(19) United States
(12) Patent Application Publication
(10) Pub. No.: US 2018/0299310 A1
(43) Pub. Date: Oct. 18, 2018

(54) LIQUID DOSING DEVICES

(71) Applicant: REIKE PACKAGING SYSTEMS LIMITED, Leicester Leicestershire (GB)

(72) Inventor: Simon Christopher KNIGHT, Bridgend Mid Glamorgan (GB)

(73) Assignee: REIKE PACKAGING SYSTEMS LIMITED, Leicester Leicestershire (GB)

(21) Appl. No.: 15/766,648

(22) PCT Filed: Sep. 30, 2016
(86) PCT No.: PCT/EP2016/073511

§ 371 Date: Apr. 6, 2018

(30) Foreign Application Priority Data
Oct. 7, 2015 (EP) 1517754.6

(51) Int. Cl. G01F 11/26; G01F 11/04

(52) U.S. Cl. CPC G01F 11/265; G01F 11/04

(57) ABSTRACT

A dosing device is described, for dispensing doses of liquid from a container. It has an outlet passage with a front outlet tube (44) and a control chamber (2,29) positioned behind the front outlet tube. A flow path for dosed flow of liquid squeezed from the container leads in around the front of the control chamber (2,29) to the outlet tube (44), via flow openings (23). The control chamber (2) has control openings (28) to admit a restricted flow and time the fall of a blocking piston (3) to a blocking position where it blocks the outlet passage to terminate a dose. To improve uniformity of dosing, the outlet tube (44) has a tortuous flow-restricting formation (449) formed by a set of inward radial finger projections (49).

### FIELD OF THE INVENTION

This invention has to do with devices adapted for dispensing doses of liquid from a container, and containers incorporating such devices. In preferred embodiments the devices are used in, or adapted for use in, squeezable containers. A preferred field of use is containers for detergents or other cleaning liquids, fabric conditioners, foods such as sauces and the like, and especially for domestic or household use.

### BACKGROUND

In preferred embodiments the invention is concerned with liquid dosing devices of a kind having an outlet passage leading to a front discharge opening, past or around a control chamber positioned behind the front discharge opening and having one or more rear control openings to admit a restricted flow of liquid from the container interior into the control chamber. An obturator (blocking element) such as a sliding piston is in the control chamber and adapted to advance, during dispensing, under the influence of liquid flowing into the control chamber behind it through the control opening(s). When the obturator has advanced sufficiently it blocks the outlet passage to terminate the dose. Usually the outlet path of the liquid leads from the container interior forwardly past outside the control chamber and then radially inwardly, around or through the front of the chamber wall, in front of the obturator to the discharge opening which is typically axial or central at the front of the device. The front of the chamber wall may then have or border onto one or more circumferentially-distributed flow openings as part of the outlet passage.

Dosing dispensers as described above, referred to below as being “of the kind described”, are known. See for example our own EP-A-0274256 and WO2005/049477 which describe dispensers with a discharge opening having a rearwardly-projecting tubular extension from the front cap which provides at the same time a seat for the obturator to rest against and thereby block the outlet passage, and also a structure for guiding the outgoing flow partly back towards the obturator to control its advance. A dump valve arrangement may be provided at the back of the control chamber to allow rapid escape of liquid from the control chamber behind the obturator after a dose has been dispensed, to speed return of the obturator to its rearward (starting) position ready for another dose. The dump valve closes during dispensing—under gravity and/or forward fluid pressure—so that liquid enters the control chamber only through the control opening(s). It opens after dispensing—under gravity and/or reverse fluid pressure—so that liquid can escape more rapidly than if the only escape route were through the control opening(s)

The size of dose depends partly on the cross-sectional area and flow profile of the outlet passage, and partly on the dosing time which depends in turn on the size of the control or timing openings in the control chamber, and also of course substantially on the viscosity of the liquid being dispensed. This dependence is complex and best optimised by real testing not least because many, indeed most, household liquids are substantially non-Newtonian e.g. shear thinning. In practice, the dose also varies in use according to the force of squeezing the container, and this variation is undesirable. Particular difficulties arise with this when dispensing lower-viscosity liquids, especially those with viscosity (at room temperature 25° C.) below about 100 mPa·s, and even more so below about 50 mPa·s, which includes for example a wide variety of commonly-used liquid preparations such as cleaning liquids.

It would therefore be desirable to modify dosing dispensers, especially those of the kind described, to make the dose less sensitive to squeeze force variation and/or to make the dose variation less when the liquid is of relatively low viscosity.

Another recurring problem is restoration time, i.e. the time for the obturator to return to its start position in the control chamber, so that a new dose of the correct size can be dispensed. This time should always be as short as possible.

### THE INVENTION

In this application we make new proposals useful in dosing dispensers, and particularly in those of the kind described.

We have found that relative improvements in in speed of restoration, desirable combined with improved dose uniformity, especially with lower-viscosity products, can be achieved by providing a novel formation of the discharge outlet. In known dispensers of the kind described the discharge outlet is normally provided with or as a generally cylindrical outlet tube, sometimes with an internal diameter restriction towards its external opening. Our proposal is to form the discharge outlet so as to discriminate strongly between fluids of different viscosity, specifically, between the product to be dispensed and air, by including a tortuous or intricate formation past which or through which fluid must flow when passing through the outlet.

Such a formation presents a much higher relative resistance to outflow of the liquid product to be dispensed than it does to the inflow of air which flows into the container through the outlet after each dispensing operation, because of the great difference in viscosity between liquid and air. We have found in experiments that by progressively restricting the size of the discharge outlet opening, uniformity of dosing (especially for lower viscosity products) can indeed be improved and especially in relation to variation in squeezing force. However this was found to cause difficulties with restoration of the obturator. We discovered that these difficulties were due to restriction of air inflow after dosing inhibiting the escape of liquid back through the various flow openings of the device and into the main container. By providing the intricate or tortuous outlet passage formation, with a high specific surface area, resistance to airflow could be increased relatively much less than the resistance to liquid product flow and a relatively larger flow area can be provided. Accordingly, the invention was made.

Thus in a first aspect the invention provides a dosing device for dispensing doses of liquid from a container, the device defining an outlet passage with a front discharge opening and having a control chamber positioned behind the front discharge opening, a flow path leading from past or around the control chamber to the outlet passage by way of one or more flow openings adjacent the front of the control chamber, the control chamber having one or more control openings to admit a restricted flow of liquid into the control chamber from a container for said liquid on which the device is provided in use, and an obturator in the control chamber which is movable in the control chamber to a blocking position where it blocks the outlet passage to terminate a dose;

wherein the outlet passage has a tortuous flow-restricting formation.

The tortuous formation may comprise a plurality of inward projections from a wall of the outlet passage, such as a set of radial finger projections extending from a wall of the outlet passage to at or adjacent a centre thereof. Additionally or alternatively it may comprise a plurality of spaced elongate elements defining plural subsidiary flow passages between them. The skilled person will understand that a wide range of options exists for resisting flow with high viscosity dependence. Alternatives include, for example, sinuous, bent or twisted portions of the outlet passage itself, or the provision of a coarse mesh or grille across the passage or part of it.

Projections may be cantilevered in from the tube wall of the outlet passage. They may be perpendicular to the tube axis. This orientation facilitates manufacture, e.g. by moulding. The projections may be in a centrosymmetric arrangement.

The tortuous formation may be localised at one axial position of the outlet passage. The outlet passage may comprise an outlet tube with a straight tube portion, preferably cylindrical, leading to the front discharge opening. The tortuous formation may be in the straight tube portion. Desirably there are open flow cross-sections of the tube portion before and/or after the tortuous formation.

The formation restricts the flow area, usually at an axially-localised position of the passage. Typically however the formation occupies less than 50%, preferably less than 45% or less than 40% of the flow cross-section present in the outlet passage e.g. outlet tube before and after the tortuous formation.

Preferably the tortuous formation is formed as a single moulding, more preferably as part of a moulded component in one piece with the outlet passage component, optionally in one piece with a front cap of the device.

As in the known devices of the kind described, the device preferably comprises a dump valve arrangement at the back of the component defining the control chamber to allow liquid to escape from the control chamber behind the obturator. This valve may have a valve seat and a dump valve member, preferably a ball. These may make a convergent guiding engagement with one another, to make a good seal in the closed condition.

The device may comprise a front cap element through which the outlet passage and discharge opening are defined, usually centrally. This may also comprise a rearwardly-projecting tubular extension of the outlet passage e.g. outlet tube, presenting a seat against which the obturator abuts in the blocking position to close the passage.

Usually the tortuous formation will be downstream (forward) of the passage position blocked by the obturator.

As is known, the obturator may be a piston slidable in the control chamber. It may have guide fins to align it axially in the chamber.

For use the dosing device as proposed herein is mounted on a container to constitute a dosing dispenser. Preferably the container is resiliently squeezable. This is known.

The invention is especially useful for dispensing lower-viscosity liquids such as those whose viscosity at room temperature (25° C.) is more than 10 mPa·s and less than 100 mPa·s. More generally, the liquid may typically have a viscosity less than 100 mPa·s, preferably less than 80 mPa·s, more preferably less than 60 mPa·s and most typically less than 50 mPa·s. For reference, water at room temperature has a viscosity of 1 mPa·s. The viscosity of the liquid product herein is usually 5 mPa·s or more, more usually 10 mPa·s or more, or 20 mPa·s or more.

In general, in preferred constructions the control chamber and its connection structure are a single moulded unit, connecting to a front cap component of the device which also includes, mounts or defines a discharge outlet, and has means for securing it onto/into a container neck opening, with the control chamber component projecting back inside the container neck with lateral or radial clearance for the outflow of product past it. The device preferably has an outer cover cap.

The cover cap may include a plug closure for the discharge opening. The cover cap may be integrally hinged to a front cap as described.

The form of the obturator is not particularly limited. It may be a swinging element or a linearly-moving piston. It need not make a sealing fit in the control chamber, provided that it will substantially occupy the area therein so as to be moved forward reliably by flow of liquid into the control chamber behind it. Its usual components are a blocking portion, for engaging with the outlet passage to block it, and guide means for guiding its movement in the control chamber. The guide means may comprise axially-elongate elements distributed around a periphery of the obturator, e.g. fins or lugs. The blocking portion may be a simple web or plate, e.g. if the outlet passage provides a suitable rearwardly-projecting seat or seal periphery for it to abut against. Additionally or alternatively the blocking portion may include a forward fitting projection to engage in the outlet passage or its discharge opening, but this is less preferred because of the greater tendency for sticking.

In general, the components herein may be moulded plastics components, joining by snap or press engagements without requiring discrete fasteners. The device is therefore suitable for implementation in mass-produced containers e.g. for household products, cleaning products, or food products. A detergent liquid is a particular embodiment, e.g. having viscosity at 25° C. between 20 and 60 mPa·s.

An embodiment of our proposals is now described by way of example, with reference to the accompanying drawings in which:

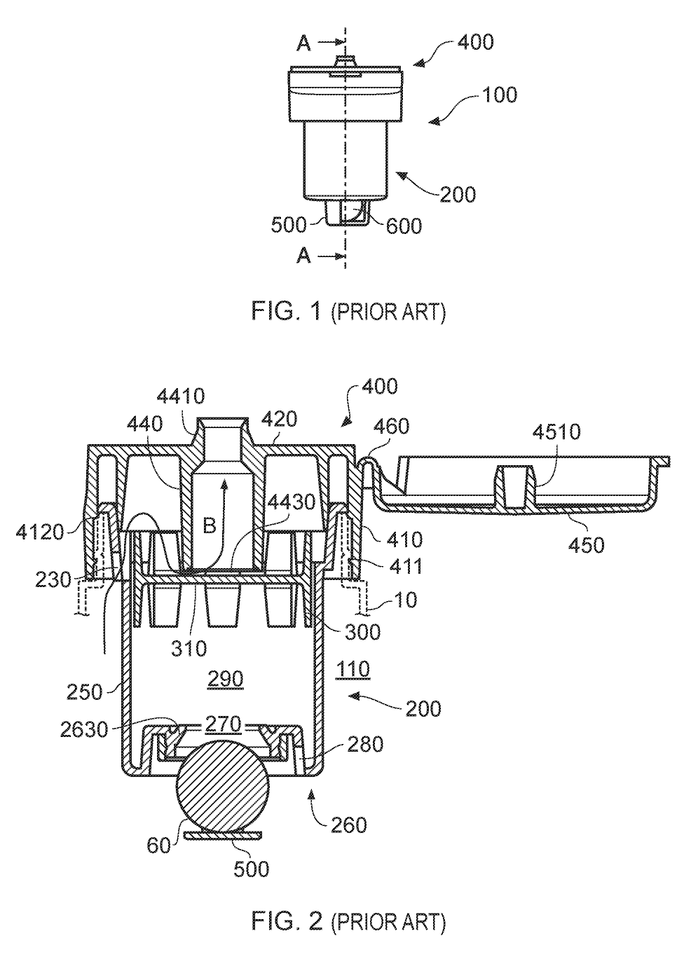

FIGS. 1 and 2 are respectively a side elevation and an enlarged section at A-A of a prior art dosing device of WO2005/049477;

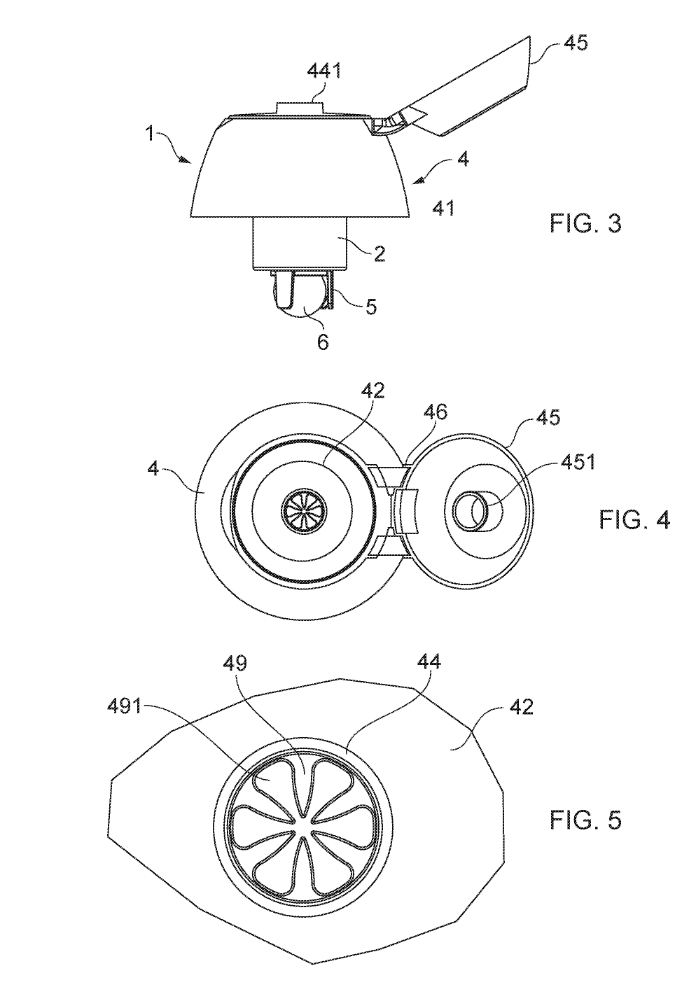

FIG. 3 is a side view of a dosing device embodying the invention;

FIG. 4 is a plan view of the dosing device;

FIG. 5 is a fragmentary enlarged view, also a plan, showing details of the discharge passage (at the centre of FIG. 4);

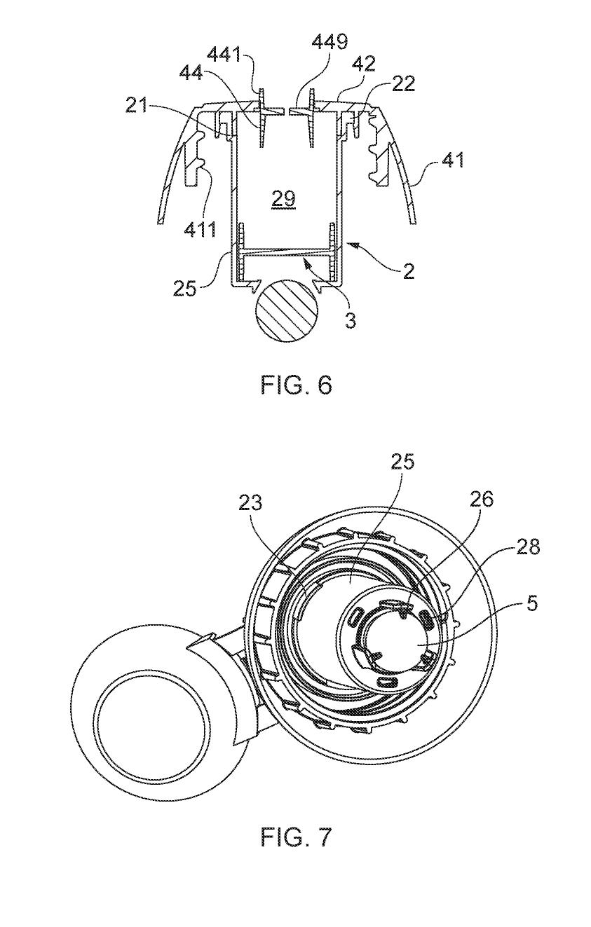

FIG. 6 is an axial sectional view of the dosing device, and

FIG. 7 is an oblique view from below the dosing device.

First, the general features and principles of an embodiment of a dispenser of the kind described are described with reference to FIGS. 1 and 2 which show a prior art dosing device 100 as disclosed in WO2005/049477. The dosing dispenser device 100 is designed to fit onto the open neck of a plastic container 10, indicated in broken lines in FIG. 2. It has a front cap component 400 which is a one-piece moulding comprising a front plate 420, a central outlet tube 440 with a forwardly projecting nozzle 4410, an outer securing skirt 410 having a securing formation 4110 by which it fixes onto the container neck 10, and a cover cap 450. The cover cap joins to the rest of the cap component 400 through an integral butterfly hinge 460 so that the cap 450 tends towards being either shut or fully open.

The underside of the cap 450 has an integral nozzle plug 4510 which plugs the nozzle 4410 when the lid is shut.

The second major component of the device is a control chamber or insert cylinder component 200, sometimes called a timing chamber. This component consists essentially of a closed cylindrical sidewall 250 defining internally a control chamber 290, and having around its front edge a connection structure in the form of an integral forward extension 210, meeting the cylinder sidewall 250 and having a front fixing lip 220 which snaps into the cap skirt 410 (FIG. 2).

Three equidistantly-spaced flow openings 230 are provided through the forward extension 210.

Behind the front plate 420 of the cap 400 the central cylindrical outlet tube 440 projects back into the open front end of the control chamber 290.

The described cap and insert are preferably of polypropylene, but other materials are possible.

An obturator or blocking piston 300 is enclosed in the control chamber 290, and has a flat central disc 310 with a set of axially-projecting integrally-formed peripheral guide lugs around its edge. The control piston 300 fits substantially—i.e. occupying nearly all the cross-section but as a loose fit—into the control chamber 290 so as to be freely slidable in it, between a forward position in which its central web surface 310 lies against and blocks the rear entrance to the outlet tube 440, and a rear position in which it lies against the rear wall 260 of the chamber 200.

An outlet passage for liquid in the container therefore exists, as indicated by arrow B, from the container's interior space 110 forward through the radial clearance between the chamber component 200 and container neck 10, forward and in through the flow openings 230 to the space between cap 400 and chamber 290 (and in front of the control piston 300), in and forward through the rearward extension of the outlet tube 440 and out through the discharge nozzle 4410.

The rear wall 260 of the control chamber component 200 features a central discharge or dump opening 270 surrounded by a convergent valve seat 263. Small discrete control openings or timer openings 280, in this case three openings spaced equidistantly, penetrate the rear wall towards its edge.

A retaining cage 500 is snap-fitted onto the centre of the rear wall 260. In this cage a plastic valve ball 600 is retained. The ball 600 cannot escape from the cage but when it lies against the cage back plate, as in FIG. 2, there is a substantial clearance for flow out of the control chamber 290 through the dump opening 270, around the ball and away through the cage windows into the container interior 110. When the ball 600 lies in a forward position however its guided engagement in the convergent seat 263 completely seals the dump opening 270 and the only communication between the container interior 110 and the control chamber 290 is through the small control openings 280.

Normally the container stands upright with the device 100 facing upwardly as shown. To dispense a dose the container is upturned and squeezed. Liquid flows out to the discharge nozzle along the outlet path (arrow B). At the same time the valve ball 600 moves forward, urged by gravity and the forward movement of liquid in the container, so that it blocks the dump opening 270. Liquid nevertheless flows through the control openings 280 from the container interior into the control chamber 290 behind the control piston 300. At the beginning of the operation the control piston 300 is at the back of the chamber 290, and the initial rush of liquid along the outlet path B fills up the front part of the device (in front of the piston 300) tending to delay it, in particular preventing it from simply falling under gravity. However as liquid gradually enters the control chamber 290 under squeeze pressure through the restricted openings 280 the piston 300 moves forward, at a predetermined rate depending on the size of the openings 280, the viscosity of the liquid and the size of the outlet tube 440. Eventually its central web or plate 310 meets the rear circular edge 4430 of the outlet tube 440 and blocks the discharge passage, immediately stopping the flow and terminating the dose.

The container may then be turned upright and the squeeze released. Under the influences of gravity, the weight of liquid in the control chamber 290 and air inflow from suction as the squeeze is released, the dump valve ball 600 falls open and liquid flows out from the control chamber 290 back into the container. At the same time there is a flow of liquid from the front of the device back through the flow openings 230 into the container.

Where the squeezed container exerts a sufficiently powerful suction, it may be possible to open the dump valve and restore the control piston 300 to its rear position without having to bring the container upright; suck-back of product from the nozzle area may be achieved at the same time. If such powerful suction is available a further dose may be dispensed without having to bring the container upright, simply by squeezing the container again to shut the dump valve and re-initiate the control function.

Referring now to FIGS. 3 to 7, a dosing device 1 embodying the present invention as shown. The general operation of the device is in line with the operation of the prior art device described above, and analogous components are referred to by analogous reference numerals (reduced by 1000 or 100). In each figure the device is shown with the cover cap 4 open, and with the device separate from a container with which it is used. In the device shown the securing formations 411 comprise a screw thread on the inside of the cap instead of the snap rib of the prior art embodiment, but either may be used. The dosing device shown is used in conjunction with a squeezable container of a liquid product, such as a household detergent liquid of viscosity from 20 to 60 mPa·s at 25° C. Details of the squeezable container and liquid product are not given further because they are well known to the skilled person.

In this embodiment the resilient downward tabs 5 forming a cage for the valve ball 6 are formed as part of the base or lower end 26 of the control chamber 2. The control openings or timing openings 28 can be seen in FIG. 7, which also shows one of the front flow openings 23 through which the outflowing liquid enters from the container interior to the interior of the dosing device in front of the blocking piston 3.

A distinctive feature of the device 1 is a tortuous flow-restricting formation 449 formed in the outlet tube 44, and shown in more detail in FIG. 5. As indicated in the sectional view of FIG. 6, this formation is conveniently formed in one piece with the outlet tube 44, as a moulding, and this moulding may either be inserted (bonded or moulded-on) in the cap component 4 as shown in FIG. 6, or may be moulded integrally with it.

Referring to FIG. 5, the formation comprises a set of finger projections 49, each projecting radially inwardly from the wall of the generally cylindrical outlet tube 44 towards its centre, and all at the same axial position, i.e. in one plane or layer. The finger projections 49 reach nearly to the centre of the flow path, defining between them a set of subsidiary flow openings 491. In the illustrated embodiment there are six fingers, but their number, dimensions and shape may be adjusted according to convenience of manufacture and on the viscosity of the liquid to be dispensed. The skilled person will appreciate that, by forcing an intricate flow path through the subsidiary passages 491, with a high specific surface, the formation 449 provides much greater flow resistance to a liquid of moderate viscosity than it does to a flow of air. We have found that with this modification, the speed and reliability of restoration of the blocking piston 3 after each dispensing stroke are markedly improved when compared with a dosing device in which the same restriction of cross-sectional flow area through the outlet is provided by a simple cylindrical outlet cross-section.

The listing of claims replaces all previous versions of the claims:

1. A dosing device for dispensing doses of liquid from a container, the device defining an outlet passage with a front discharge opening and having a control chamber component defining a control chamber behind the front discharge opening, a flow path leading from past or around the control chamber component to the outlet passage by way of one or more flow openings adjacent the front of the control chamber, the control chamber component having one or more control openings to admit a restricted flow of liquid into the control chamber from a container for said liquid on which the device is provided in use, and an obturator in the control chamber which is movable in the control chamber to a blocking position where it blocks the outlet passage to terminate a dose;
wherein the outlet passage has a tortuous flow-restricting formation.

2. A dosing device according to claim 1 in which the tortuous formation comprises a plurality of inward projections from a wall of the outlet passage.

3. A dosing device according to claim 2 in which the tortuous formation comprises a set of radial finger projections extending from the wall of the outlet passage to at or adjacent a centre thereof.

4. A dosing device according to claim 1 in which the tortuous formation comprises a plurality of spaced elongate elements defining plural subsidiary flow passages between them.

5. A dosing device according to claim 2, in which the outlet passage is provided as an outlet tube with a straight tube portion leading to the front discharge opening, and the tortuous formation is in the straight tube portion.

6. A dosing device according to claim 5 in which the tortuous formation is localised in the outlet tube, with open flow cross-sections of the tube before and after the tortuous formation.

7. A dosing device according to claim 5 in which the straight outlet tube portion is generally cylindrical.

8. A dosing device according to claim 1 in which the tortuous formation is comprised in a moulded component in one piece with the outlet passage.

9. A dosing device according to claim 1 comprising a dump valve arrangement at the back of the control chamber to allow liquid to escape from the control chamber behind the obturator.

10. A dosing device according to claim 9 in which the dump valve comprises a dump valve seat and a dump valve member which make a convergent guiding engagement with one another, the dump valve member entering the dump valve seat to make a seal in a closed condition of the dump valve.

11. A dosing device according to claim 10 in which the dump valve member is a ball.

12. A dosing device according to claim 1 comprising a front cap component through which the outlet passage and discharge opening are centrally defined, and providing a rearwardly-projecting tubular extension of the outlet passage presenting a seat for the obturator to rest against in the blocking position.

13. A dosing device according to claim 1 in which the tortuous formation is downstream of where the outlet passage is blocked by the obturator.

14. A dosing device according to claim 1 in which the outlet path for liquid leads forwardly outside the control chamber component and then radially inwardly, by way of said flow opening(s), around or through the front of a wall of the control chamber component to the outlet passage which is central.

15. A dosing device according to claim 1 in which the obturator is a piston slidable in the control chamber.

16. A dosing dispenser comprising a dosing device according to claim 1 mounted on a container.

17. A dosing dispenser according to claim 16 in which the container is resiliently squeezable.

18. A dosing dispenser according to claim 16 in which the container contains a said liquid to be dispensed and the viscosity of the liquid at room temperature (25° C.) is more than 10 mPa·s and less than 100 mPa·s.

19. A dosing dispenser according to claim 18 in which the liquid is a detergent liquid.
